(19) United States
(12) Patent Application Publication
(10) Pub. No.: US 2006/0126456 A1
(43) Pub. Date: Jun. 15, 2006

(54) Method for executing a track jump of an explorer head to retireve data from aa carrier

(75) Inventor: Tony Petrus Van Endert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,227

(22) PCT Filed: Nov. 5, 2003
(86) PCT No.: PCT/IB03/04982

§ 371 Date: May 24, 2005

(30) Foreign Application Priority Data
Nov. 27, 2002 (EP) 02292936.8

(51) Int. Cl. G11B 7/00

(52) U.S. Cl. 369/44.32; 369/53.12

(57) ABSTRACT

An apparatus for processing data which are placed on a data carrier (1) in various locations defined y locations codes and which are organized in accordance with data address codes for retrieving them, this apparatus comprising an explorer head (15) mounted in a sledge (16) for reading and/or writing data onto the carrier, a displacement measurer for measuring the position of said sledge, a displacement device (17) for placing said explorer head in a given position in accordance with a position code which is provided for executing an address jump. And a translator device for transforming data address codes into location codes having. The translator device has a correspondence table to establish a first correspondence between location codes and data address codes and updating means for establish a second correspondence more accurate than the first correspondence by taking account of previous jump.

The present invention relates to an apparatus for processing data which are placed on a data carrier in various locations defined by location codes and which are organized in accordance with data address codes for retrieving them.

This apparatus finds many applications, notably for data carriers constituted by optical discs. These optical discs can be read or written by the user. A problem is how to retrieve data which are spored in various locations on the disc. This may cause a jump of the head from a first location to a second location far removed from the first one.

The U.S. Pat. No. 4,679,103 discloses an apparatus in which measures are provided for performing the jump with a certain speed and with accuracy, but these measures involve some complications.

For executing a jump which has to be performed quickly the invention proposes a solution which can be implemented very easily without extra cost. Therefore, the invention proposes such an apparatus for processing data which are placed on a data carrier, in various locations defined by location codes and which are organized in accordance with data address codes for retrieving them, this apparatus comprising:
an explorer head mounted in a sledge for reading and/or writing data onto the carrier,
a displacement measurer for measuring the position of said sledge,
a displacement device for placing said explorer head in a given position in accordance with a position code which is provided for executing an address jump,
a translator device for transforming data address codes into location codes, having:
   a correspondence table to establish a first correspondence between location codes and data address codes, and
   updating means for establishing a second correspondence more accurate than the first correspondence by taking account of previous jumps.

The invention also proposes a method of executing a jump of an explorer head in view of retrieving data on said carrier at a target address defining data on said carrier, which method comprises the following steps of:
reading the present position of the head and the data address on said carrier,
calculating the displacement of the head for going from the present position to the target position by using a correspondence calculation involving parameters to be updated,
acting on said head for executing said displacement,
reading the new position and the new data address,
updating said parameters for the next jump.

These and other aspects of the invention are apparent from and will be elucidated, by way of non-limitative example, with reference to the embodiment(s) described hereinafter.

In the drawings:

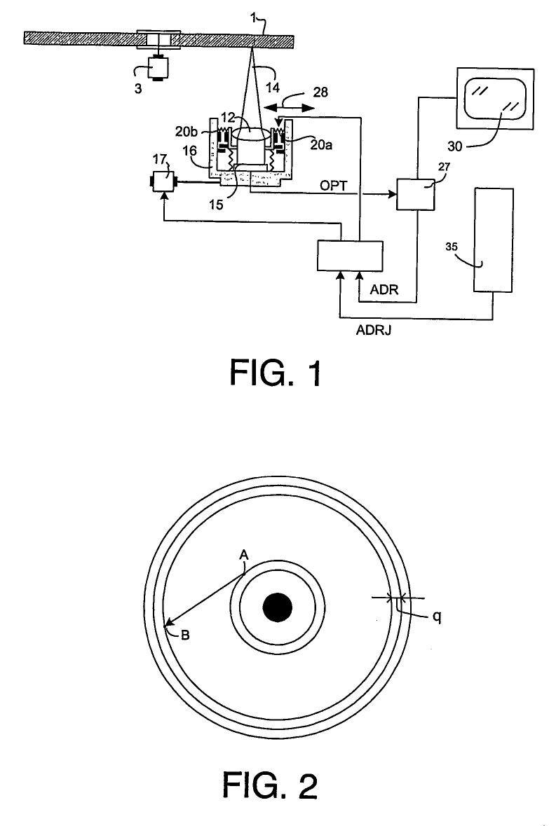

FIG. 1 shows an apparatus in accordance with the invention,

FIG. 2 shows a data carrier having the form of an optical disc,

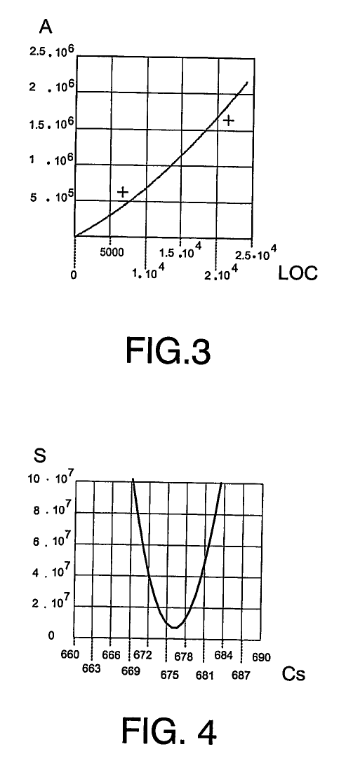

FIG. 3 is a curve which shows a correspondence between address data and a head explorer location,

FIG. 4 is a curve which shows the evolution of the summation of squares of deviations between address data and locations,

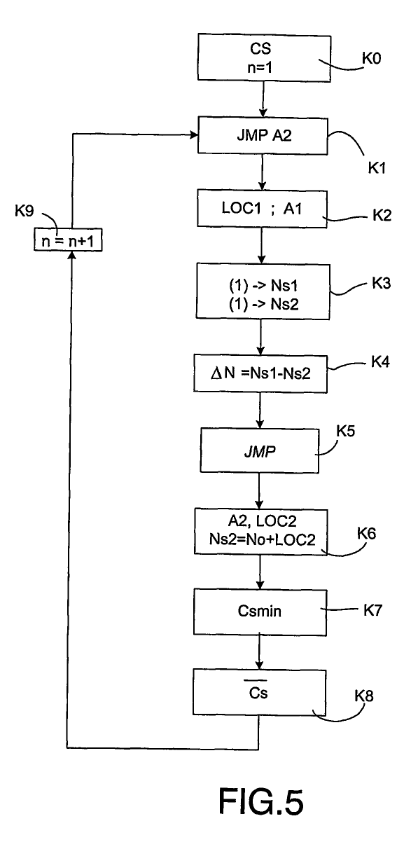

FIG. 5 is a flow chart explaining a jumping method in accordance with the invention.

FIG. 1 shows an apparatus in which a data carrier 1, notably an optical disc is placed. The data carrier is shown in cross-section. On this carrier, which is driven into a circular movement by a motor 3, a lens 12 focuses a laser light beam 14. The laser is mounted in an Optical Pickup Unit (OPU) 15, which is placed in a sledge 16 which is moved by a motor 17 for large displacement. Inside this sledge some tracking devices 20a and 20b, usually called actuators, are provided for small displacements. These displacements are performed in directions indicated by arrows 28. The signal OPT at the output of the unit 15 is applied to a signal distributor 27, which provides signals to a display unit 30 so that the content of the disc can be displayed with some other information useful for the use of the apparatus. The distributor also provides working signals, among them the address code ADR, which is read from the disc. A control device 35 is in charge of the control of the apparatus. This control device 35 can order jumps to be performed from one location to another for reading data. The other location is defined by an address code ADRJ.

FIG. 2 shows an optical disk. It is assumed that the apparatus is reading data. The point A shown in this Fig., indicates the current position of the head on a track having a spiraling shape. This point A corresponds to an address code ADR(A). The point A is also defined by its mechanical position. Two parameters define this mechanical position: the position inside the sledge and the position of the sledge itself. The problem occurs when a new address code comes from the control device 35. This new address code corresponds to data placed in a point B. The displacement to be done by the sledge 16 is not defined with accuracy, and it is not sure to find quickly the right data defined by this address code. Some relationships can be used to retrieve data at the point B. The relationships below are related to CD optical discs and DVDs respectively.

$$CD \text{:} N ≡ \frac{R}{s} = \sqrt{{( \frac{{R}_{0}}{s} )}^{2} + \frac{q \cdot v}{π \cdot {s}^{2}} \cdot {T}_{s}} = \sqrt{{N}_{0}^{2} + {C}_{s} \cdot {T}_{s}} \\ DVD \text{:} N ≡ \frac{R}{s} = \sqrt{{( \frac{{R}_{0}}{s} )}^{2} + \frac{q \cdot {L}_{s}}{π \cdot {s}^{2}} \cdot {A}_{r}} = \sqrt{{N}_{0}^{2} + {C}_{s} \cdot {A}_{r}} \qquad ( 1 )$$

Where:
Ts is the subcode/ATIP time in [s] (CD),
Ar is the (relative) sector address (DVD) or ADIP address (DVD+R(W)), these parameters are the ADR(A) already mentioned,
No means reference sledge position for a radius=Ro (see below),
R₀ is the radius in [m] where T=0 (CD) or A=0 (DVD). This reference radius is mentioned in the disc standard; for CD=25 mm+0/−0.2 mm is at address T=150 frames (=2 sec), for DVD=24 mm+0/−0.2 mm is at address A=0x30000),
v is the mastering speed in [m/s] (CD)
q is the track pitch in [m]
s is the sledge displacement increment
Lₛ is the sector/ADIP word length in [m] (DVD)
N is the PCS position with respect to spiral center

In practice, the relationship between disc addresses and sledge position is not as accurate as is needed to reach the target address within actuator range with only ‘one’ sledge displacement. This mismatch between disc addresses and sledge position is caused by tolerances of the disc and the sledge mechanism. Some disc tolerances are track-pitch, channel bit length, etc. Tolerances of the sledge mechanism are friction and play, etc is the sledge movement, which result in a wrong position between sledge and actuator. The consequence of this mismatch is that the sledge displacement is wrong (cannot reach the actuator range). This means that there are more than one sled displacements necessary for one access.

An embodiment of the invention iimproves the above process. It increases the access performance on an optical disc in an optical storage system (robustness, access time). The idea of the invention is to “teach” the behavior of the sledge system in combination with the inserted optical disc. This means that the system will learn the relationship between disc addresses and sledge position for a certain disc and sledge mechanism, based on previously executed sledge displacements. This will be done by two measurements per displacement (at start/stop position of an access to an optical storage system) and some mathematical calculations (see example below).

### EXAMPLE

A sledge displacement (jump) during an access procedure is preceded by two calculations according to above-mentioned equation (1): first one to find the initial position LOC₁ (and address A₁) and then one to find the target position LOC₂ (and address A₂). The number of steps to jump then equals ΔN=LOC₂−LOC₁. LOC₁ is the relative position (with respect to the reference position). The method will determine the Cₛ value by a self-teaching procedure (without track counting), to achieve an accurate sled jumping performance.

FIG. 3 shows a quadratic relationship (y=ax²+bx) between addresses and sledge (PCS) positions. This relationship can be considered a correspondence table. During to the above-mentioned tolerances, however deviations will occur between addresses and PCS positions (see FIG. 4). To eliminate these errors by determining Cs, a self-teaching jump algorithm is made. The system learns from previous jumps made with a certain disc and on a certain CD/DVD mechanism. The method used, will calculate the deviation from the ideal curve (FIG. 4) for the inserted optical disc. The ideal curve can be described by following equation.

$$A = \frac{1}{{C}_{S}} \cdot {LOC}^{2} + \frac{2 \cdot {N}_{0}}{{C}_{S}} \cdot LOC \qquad ( 2 )$$

where No=Ro/s is constant for a certain disc type.
This means that the summation S of the squares of the deviations, of the two measurements made in a jump, must be minimal (see equation (3) and FIG. 4).

$$S = {( \frac{{LOC}_{1}^{2}}{{C}_{S}} + \frac{2 \cdot {N}_{0}}{{C}_{S}} \cdot {LOC}_{1} - {A}_{1} )}^{2} + {( \frac{{LOC}_{2}^{2}}{{C}_{S}} + \frac{2 \cdot {N}_{0}}{{C}_{S}} \cdot {LOC}_{2} - {A}_{2} )}^{2} \qquad ( 3 )$$

Cₛ is determined by using the partial derivative of S to Cₛ equal zero.

$$\frac{\partial S}{\partial {C}_{s}} = 0 \qquad ( 4 )$$

It is possible to derive Csₘᵢₙ where n=2 (2 measurement positions)

$${C}_{{S}_{min}} = \frac{4 \cdot {N}_{0}^{2} \cdot {\sum }_{i = 1}^{n} {LOC}_{i}^{2} + 4 \cdot {N}_{0} \cdot {\sum }_{i = 1}^{n} {LOC}_{i}^{3} + {\sum }_{i = 1}^{n} {LOC}_{i}^{4}}{2 \cdot {N}_{0} \cdot {\sum }_{i = 1}^{n} {LOC}_{i} \cdot {A}_{i} + {\sum }_{i = 1}^{n} {LOC}_{i}^{2} \cdot {A}_{i}} \qquad ( 5 )$$

This Cₛ value is then used for the calculation of the next jump, with equation (1). To protect the measured information against errors, Cₛ can be filtered by e.g. averaging the current and the previous Cₛ values (or more) and taking this value into account in the real jump calculations, see equation (6):

$${Cs}_{n + 1} = \frac{{Cs}_{n - 1} + {Cs}_{n}}{2} \qquad ( 6 )$$

This Csₙ₊₁ value will be used for calculation of the next jump, with equation (1), etc. The result is that we will have the correct Cₛ value after a flew sledge jumps for a certain inserted optical disc and a certain sledge mechanism. This means that only one sledge displacement is needed to reach the actuator range.

FIG. 5 is a flow chart for explaining the method used for executing a jump. This flow chart shows many cases corresponding to elementary tasks:

The case K0 is an initializing task, which puts in some values for variables involved in this method at the start of the apparatus using this method.

The case K1 indicates that a jump is requested. The destination address provided by this jump is ADRA2.

The case K2 indicates the reading of actual parameters, the address ADRA1 and the sledge position LOC1.

The case K3 indicates two calculations for determining Ns1 and Ns2 concerning the present and target position by using equation (1).

The case K4 indicates the jump to be performed.

The case K5 indicates the operation of the jump.

The case K6 indicates the reading of address ADRA2 and the position LOC2 obtained at the end of the jump. Ns2 is computed by Ns2=No+LOC2.

The case K7 indicates the calculation of the new Csmin by using the equation (5).

The case K8 indicates a mean calculation by using the equation (6).

The case K9 indicates that the value of n which is used in the equation (5) is increased by one unit.

1- An apparatus for processing data which are placed on a data carrier in various locations defined by location codes and which are organized in accordance with data address codes for retrieving them, this apparatus comprising:
an explorer head mounted in a sledge for reading and/or writing data onto the carrier,
a displacement measurer for measuring the position of said sledge,
a displacement device for placing said explorer head in a given position in accordance with a position code which is provided for executing an address jump,
a translator device for transforming data address codes into location codes, having:
a correspondence table to establish a first correspondence between location codes and data address codes,
updating means for establishing a second correspondence more accurate than the first correspondence by taking account of previous jumps.

2- An apparatus as claimed in claim 1, wherein a correspondence table is formed by a first relationship which is obtained by calculation and which is a function of at least one parameter to be updated.

3- An apparatus as claimed in claim 2, wherein said updating means have an input for reading the information provided by said displacement measurer on previous jumps for adjusting said parameter to be updated.

4- An apparatus as claimed in claims 1 to 3, wherein the data carrier is an optical disc.

5- A method of executing a jump of an explorer head in view of retrieving data on said carrier at a target address defining data on said carrier, which method comprises the following steps of:
reading the present position of the head and the data address on said carrier,
calculating the displacement of the head for going from the present position to the target position by using a correspondence calculation involving parameters to be updated,
acting on said head for executing said displacement,
reading the new position and the new data address,
updating said parameters for the next jump.

6- A method as claimed in claim 5, comprising a further step for filtering the updated parameters.
